(19) United States
(12) Patent Application Publication
(10) Pub. No.: US 2018/0375411 A1
(43) Pub. Date: Dec. 27, 2018

(54) METHOD OF DRYING THE WINDINGS OF AN ELECTRIC MACHINE AND DEVICE FOR THE IMPLEMENTATION THEREOF

(71) Applicants: Sergei Ivanovich GRUZNYH, (US); LIMITED COMPANY "TALAS ELECTRIC OY", Helsinki (FI)

(72) Inventor: Sergei Ivanovich GRUZNYH, Klin Moskovskaya obl. (RU)

(73) Assignees: Sergei Ivanovich GRUZNYH, Klin Moskovskaya obl. (RU); LIMITED COMPANY "TALAS ELECTRIC OY", Helsinki (FI)

(21) Appl. No.: 15/747,079

(22) PCT Filed: Jun. 27, 2016
(86) PCT No.: PCT/RU2016/000392

§ 371 Date: Jan. 23, 2018

(30) Foreign Application Priority Data
Jul. 27, 2015 (RU) 2015131052

(51) Int. Cl. H02K 15/12; H02K 11/27

(52) U.S. Cl. CPC H02K 15/12; H02K 11/27

(57) ABSTRACT

The invention relates to the field of alternating current electric machines and is intended for restoring winding insulation to its original parameters. According to the present method of drying the windings of an electric machine, a direct current having a magnitude of 10-60% of the nominal value of the current intensity in the windings is passed through the windings for intervals of 1-10 seconds. The active direct current intervals are alternated with pauses, which differ from said intervals by 0.5-1.5 times. In one embodiment of the invention, for the purpose of passing direct current through the windings, an intentionally small direct voltage is applied to the winding ends and is increased until a predetermined direct current intensity is reached. In another embodiment, the resistance of the insulation is determined during the pauses and once it has reached a given value, current is no longer supplied. The invention provides for the more rapid drying of winding insulation without the risk of damage to the insulation material.

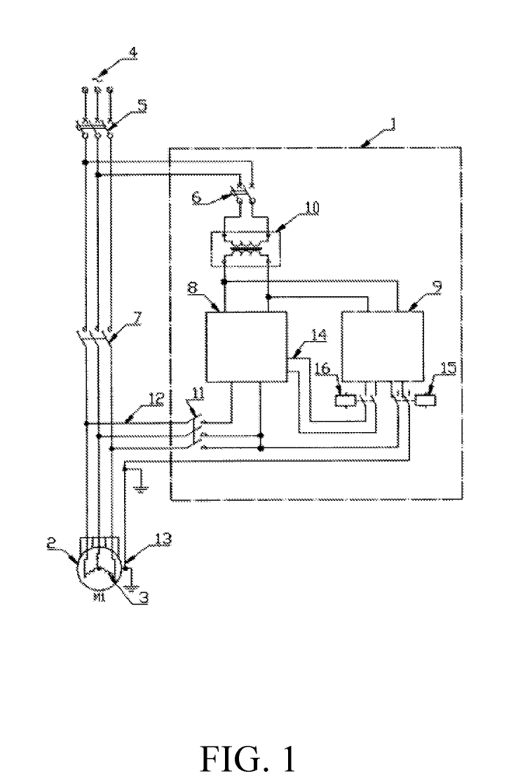

### DEVICE FOR THE IMPLEMENTATION THEREOF

This invention relates to operation of AC machines and is designed for restoration of their winding insulation performance.

An alternating current electrical machine (hereinafter—“electrical machine”) within a context of this claim is understood as a device which can cause electromechanical energy conversion or change its parameters by force of electromagnetic induction. Such devices include, in particular, electric motors, generators, transformers, electromagnets. They all are characterised by presence of at least one insulated conductor wrapped around a coil and connected to AC power source (hereinafter—“winding”).

Operation of electrical machines is accompanied by heating of windings by electric current passing through conductors. Once electrical machine is shut off and starts to cool down, moisture from ambient air adsorbs on the surface of the winding, afterwards entering the insulation material. This process will intensify significantly during operation of electrical machine under the conditions of increased humidity or when winding comes into direct contact with water. As a result, winding resistance drops causing higher risk of insulation breakdown, thus making starting and operating of electrical machine with wet winding unacceptable.

Patent publication SU1713029A1, H02K15/12, Feb. 15, 1992 describes a method of drying electrical machine winding insulation demonstrated by an example of an electric motor. This method is characterised by creating a difference of electric potential between winding and housing resulting in heating of winding and moisture removal. However, since resistance of a soaked insulation is still considerably high, proper heating of a winding will require application of high voltage: for instance, aforementioned publication quotes voltage value of 500V.

Obviously, such a high voltage applied to electric motor housing will pose a significant hazard to people nearby, hence drastically narrowing field of application of this method.

Patent publication RU2266603C1, H02K15/12, Dec. 20, 2005 describes a method of drying electrical machine winding insulation, in which insulation is heated up by energizing and heating up conductors. This method allows for higher energy efficiency and operational safety, and describes the process as follows: winding ends are energized with DC voltage through a low-voltage thyristor conducting rectified current. Drying time is set by a timer; insulation temperature is controlled during entire drying process allowing interruption the process when overheated. This method has been chosen as a prototype of claimed invention.

Main disadvantage of the prototype is a relatively fast degradation of insulation material occurring after several applications of this method. Presumably it is caused by continuous voltage supply interrupted only when insulation temperature reaches critical values, which in turn leads to very uneven heating of insulation. Inner layers are heated first; moisture migrates to colder outer layers, accumulating there in higher concentration. High concentration of moister in polymer materials followed by its fast removal disrupts material structure and reduces insulation life. Attempting to lower supplied voltage in order to provide a gentler heating rate will result in delaying drying process.

Object of invention is to facilitate drying winding insulation of an electrical machine while eliminating the risk of damaging insulation material after reducing the drying time.

Two subjects of invention are presented for accomplishment of object of invention: a method of drying electrical machine winding and an apparatus for its implementation.

Method of drying AC electrical machine winding is characterised by energizing the winding for 1-10 seconds periods with DC current at 10-60% of winding current design value, whilst periods of DC energizing alternate with pauses of duration up to 0.5-1.5 times of specified periods.

In particular case of the first subject of invention, insulation resistance is measured during pauses; DC energizing stops after the target value is achieved. The preferred outcome will include measuring insulation resistance by supplying voltage between winding and housing of electrical machine in order to determine electric current in this circuit. Voltage value between winding and housing of electrical machine might equal 20-50 V.

In a different particular case of energizing winding with DC current, invariably low DC voltage is applied to winding ends, stepping up voltage until DC target value is achieved. DC value is controlled by ampere meter connected in series with winding.

In other case of passing DC current through winding by applying DC voltage to winding ends, voltage value is calculated based on target DC value and winding insulation resistance; the latter can be premeasured.

In the preferred embodiment of the first subject of invention, DC voltage can be received by converting AC voltage using a full-wave rectifier.

In three other preferred embodiments: DC energizing periods are 5-7 seconds, DC value is 45-55% of winding current design value, periods of DC energizing alternate with pauses of duration up to 0.9-1.1 times of specified periods.

An apparatus for drying AC electrical machine winding insulation contains a DC regulator, on one side connected to AC supply, and on the other side attached to the ends of at least one electrical machine winding, creating a heating circuit. Regulator is capable of providing a DC current flow with 10-60% of design current value of electrical machine. Such apparatus also contains a control unit capable of closing the heating circuit for 1-10 seconds periods alternating it with pauses of duration up to 0.5-1.5 times of specified periods.

In particular case of the second subject of invention, control unit is attached on one side to any winding end, and on the other side to electrical machine housing, thus creating a measuring circuit. In the preferred embodiment, control unit is capable of closing and opening the measuring circuit simultaneously with opening and closing the heating circuit. In other preferred embodiment, control unit is capable of applying 20-50 V voltage to measuring circuit and measuring electric current value in aforementioned circuit.

The invention embodiment will be demonstrated by an example of an electric motor and illustrated by reference to a figure depicting structural diagram of the apparatus for drying winding insulation. The design of the apparatus is shown only to illustrate the best example of implementation of this method without limiting the scope of protected rights.

Proposed method can be implemented using device 1 connected to one, two or three windings 3 of electric motor 2. Such device can be integrated into the motor or designed as a separate apparatus connected to the motor.

The motor is powered by a three-phase AC network 4. The diagram shows circuit breakers 5 and 6 as well as contactor 7 for turning on and off motor 2.

Apparatus for drying winding insulation (hereinafter—“drying apparatus”) contains DC regulator 8 and insulation tester and control unit 9 (hereinafter—“control unit”).

DC regulator is configured in known thyristor voltage rectification circuit and is powered by step-down transformer 10 connected to AC power source through circuit breaker 6. DC regulator is attached to the ends of at least one motor winding, forming a heating circuit, wherein DC current from DC regulator 8 is supplied to windings by connecting auxiliary contactor 11 and connector wires 12.

Being energized by AC voltage, winding current value is defined by both internal resistance of the conductor and inductive resistance of the core.

Since DC current doesn't cause electromagnetic induction, it also doesn't cause any inductive resistance, thus nominal value of the current can be achieved at a substantially lower value of DC voltage. DC regulator receives alternating voltage of 20-50 V from transformer and converts it into direct voltage by full-wave detection while simultaneously lowering voltage to a value capable of generating a constant current in the winding at the level of 10-60% of the nominal value.

Nominal current value within a context of this claim is understood as a design current in electric motor winding specified for project conditions, which is usually specified by the manufacturer among other nominal characteristics or can be calculated based on motor capacity.

Control unit 9 is also powered by transformer 10, wherein one output is attached to any winding end, and the other output via earthing conductor 13—to motor housing 2, forming a measuring circuit. Windings can be disconnected from the drying apparatus by means of auxiliary contactor 11.

Control unit 9 is designed to measure and display insulation resistance, settings of critical and design values of insulation resistance. Furthermore, control unit 9 provides alternate, or, in the preferred embodiment, simultaneous connection of motor windings to either current regulator 8 energizing winding heater current, or to an output of control unit 9 applying measuring voltage to motor windings and housing for measuring current value of insulation resistance.

Method is implemented as follows.

In order to restore motor performance, winding insulation requires drying after events of water penetration (e.g. rainfall, sea waves) or long-term motor idle state under the conditions of increased humidity.

Electric motor is disconnected from power network through electromagnetic contactor 7, or, in case the latter has been previously disabled, contactor disconnection is tested; afterwards drying apparatus is turned on, supplying AC voltage to step-down transformer 10 through circuit breakers 5 and 6. Transformer secondary wiring outputs 20-50 V, while transformer provides galvanic isolation of drying apparatus with supply voltage hazardous to humans.

Critical and design values of insulation resistance are set at control panel of control unit 9. If insulation resistance is equal or less than critical value (typically 500 kiloohm), starting and operating of electrical machine is not permitted. Design resistance value is normally set as a target value, and preferably, target value is selected close or equal to design value of insulation resistance.

Current value is measured by switching on relay 15 and applying voltage 20-50V to measuring circuit via control unit. The upper and lower limits of given range are determined, based on following considerations: at voltage below 20V current is too low to be reliably measured, while voltage over 50V is sufficient to reliably measure current at any state of insulation. As the current in given circuit is an insulation current, insulation resistance is calculated based on measured current and applied voltage values.

If observed insulation resistance value is less than the specified value, measurement circuit will be disconnected from windings by relay 15 with simultaneous closure of relay 16. A signal is sent through tie-line 14 from control unit 9 to DC regulator 8, activating heating circuit and applying DC voltage to windings through contactor 11 and connector wires 12.

Set DC voltage value should provide DC current in heating circuit in the range of 10-60% of nominal motor power. If the current in heating circuit exceeds upper limit of this range, it may cause overheating and breakdown of wet insulation, while current value less that 10% of nominal cannot guarantee effective conductor heating.

Preferably, DC current value is set as follows. At first heating circuit is energized with low DC voltage, not sufficient to create DC current of required value. Current in heating circuit is controlled with an ampere meter connected in series with winding, DC voltage is gradually increased until required current value achieved; measurements can be performed by a potentiometer connected to thyristor control circuit with a signal output to regulator control panel.

In another case, resistance of winding conductor can be pre-measured; and DC voltage value required for achieving design DC current value can be pre-calculated and preset by a potentiometer before turning on contactor 6.

Usage of DC regulator ensures energy efficiency of drying process, while, due to lack of inductive reactance, design current value can be reached at a lower DC voltage value compared to AC voltage.

Studies have found that in order to avoid premature insulation material deterioration, it is advised to avoid excessive water concentration in some of its areas. To ensure this condition, insulation is heated by DC energizing the winding for 1-10 seconds periods alternating it with pauses of duration up to 0.5-1.5 times of specified periods.

Applicability of insulation heating by current impulses with specified intervals can presumably be explained by the fact that during conductor heating process water from inner insulation layers penetrates the outer layers and heats them. During the pause water partially returns to inner layers, while partially evaporating from the outer layers. Thus, during next heating periods, concentration of water penetrating into outer insulation layers will continue dropping, which results in avoiding excessive water concentration in outer layers after multiple heating cycles.

It should be noted that when DC energizing intervals are shorter than 1 second, and pauses between those intervals are kept correspondingly short, only the immediate area around insulation conductor is heated; furthermore, due to the frequent change of current value energy losses in the core are increasing, i.e. higher voltage will be required for providing specified current value. When DC energizing intervals are longer than 10 seconds, and pauses between those intervals are correspondingly long, a much greater insulation area around the conductor is heated resulting in undesired water concentration in its outer layers.

Although the claimed technical result can be achieved with all specified DC current value ranges, length of energizing periods and pauses, the highest efficiency of this method has been documented at DC value of 45-55% of winding current design value, DC energizing periods of 5-7 seconds and pauses of duration up to 0.9-1.1 times of specified periods.

Measurement circuit is closed by relay 15 with simultaneous closure of relay 16 and disconnection of heating circuit during pauses. Same as the above method, insulation resistance is measured, compared with design value and if measured value is greater than design value, DC regulator stops delivering current pulses and insulation drying process is considered completed.

Electromagnetic contactor 11 remains energized, and insulation resistance is measured repeatedly until a command to start motor is received or winding insulation resistance drops below specified value for any reason.

When measured insulation resistance value drops below specified value over time, winding insulation drying shall be carried out according to proposed drying method.

When measured insulation resistance value is found below critical resistance, e.g. in case of direct water penetration, control unit will issue an inhibit start motor command to electromagnetic contactor 7. Insulation drying will be carried out according to proposed drying method until design insulation resistance value is reached; start motor ban is lifted as soon as critical resistance value is exceeded.

If start motor command is received when insulation resistance is above critical value, control unit 9 trips contactor 11, after which a permissive signal is sent to contactor 7, windings are energized by supply voltage, and electric motor starts.

It should be noted that since specified DC value is calculated in fractions of a reference value, proposed method can be implemented for any electrical machine. A preferred embodiment here is the use of this method for electrical machines with capacity 1-1000 kW.

1. A method of drying winding insulation of an AC electrical machine by energizing its winding for 1-10 seconds with DC current at 10-60% of design value, whilst periods of DC energizing alternate with interruption of current with up to 0.5-1.5 times of energizing periods specified above.

2. The method of claim 1, in which a winding resistance is measured during the interruption of current periods; energizing stops after achievement of a resistance target value.

3. The method of claim 2, in which voltage is supplied between the winding and a housing of the electrical machine in order to determine a current value in this circuit and calculate an insulation resistance.

4. The method of claim 3, in which a voltage value between the winding and the housing of the electrical machine equals 20-50 V.

5. The method of claim 1, in which in order to energize the winding with DC, an invariably low DC voltage is applied to winding ends, stepping up voltage until a DC target value is achieved.

6. The method of claim 5, in which a DC value is controlled by an ampere meter connected in series with the winding.

7. The method of claim 1, in which DC current is passed through the winding by applying a DC voltage to winding ends, a voltage value is calculated based on a target DC value and a winding insulation resistance.

8. The method of claim 7, in which electrical resistance of a winding conductor is measured prior to applying DC voltage.

9. The method of claim 5 or 7, in which the DC voltage is received by converting AC voltage using a full-wave rectifier.

10. The method of claim 1, in which DC energizing periods last 5-7 seconds.

11. The method of claim 1, in which a DC value is 45-55% of a rated winding current.

12. The method of claim 1, in which periods of DC energizing alternate with interruption of current with of duration up to 0.9-1.1 times of specified energizing periods.

13. An apparatus for drying an AC electrical machine winding insulation, comprising:
a DC regulator connected to an AC supply on one side and to winding ends of at least one electrical machine winding on the other side, creating a heating circuit capable of providing a DC current flow with 10-60% of design current of the electrical machine, and
a control unit capable of closing the heating circuit for 1-10 seconds alternating it with interruption of current with a duration up to 0.5-1.5 times of specified energizing periods.

14. The apparatus as defined in claim 13, in which the control unit is connected to any winding end on one side, and to an electrical machine housing on the other side, thus creating a measuring circuit.

15. The apparatus as defined in claim 14, in which the control unit is capable of closing and opening the measuring circuit simultaneously with correspondingly opening and closing the heating circuit.

16. The apparatus as defined in claim 15, in which the control unit is capable of applying 20-50V voltage to the measuring circuit and measuring a current value in the aforementioned circuit.
